(19) United States
(12) Patent Application Publication
(10) Pub. No.: US 2015/0079538 A1
(43) Pub. Date: Mar. 19, 2015

(54) DENTAL ROOT CANAL FILLING MATERIAL CARTRIDGE HAVING BUILT-IN HEATING MECHANISM FOR SOFTENING THE MATERIAL

(71) Applicants: Nathan Y. LI, Malibu, CA (US); DaQing WU, Beijing (CN)

(72) Inventors: Nathan Y. LI, Malibu, CA (US); DaQing WU, Beijing (CN)

(21) Appl. No.: 14/445,013

(22) Filed: Jul. 28, 2014

Related U.S. Application Data
(60) Provisional application No. 61/859,051, filed on Jul. 26, 2013.

(51) Int. Cl. A61C 5/04

(52) U.S. Cl. CPC A61C 5/045
USPC 433/81; 206/63.5

(57) ABSTRACT

A cartridge for storing root canal filling material cartridge and an applicator device for use with the cartridge to deliver root canal filling material. The cartridge includes its own heating mechanism, built-in the cartridge body. The heating mechanism includes an electrical heating element provided around the chamber of the cartridge body, which contains root canal filling material packed in the chamber. Electrodes are provided on the exterior of the cartridge body for the heating element. The cartridge is inserted into the barrel/chamber of an applicator device, with the cartridge electrodes coming into contact with electrodes provided on the applicator barrel/chamber walls, providing external power to the heating element on the cartridge.

### PRIORITY CLAIM

This application claims the priority of U.S. Provisional Patent Application No. 61/859,051 filed on Jul. 26, 2013, which is fully incorporated by reference as if fully set forth herein. All publications noted below are fully incorporated by reference as if fully set forth herein.

### BACKGROUND OF THE INVENTION

1. Field of the Invention

The present invention is directed to devices for softening material for filling dental root canals, and in particular to a cartridge containing dental root canal filling material for use in an applicator device.

2. Description of Related Art

Dental root canal treatment generally involves three stages: shaping, cleaning and obturation (generally involving filling and sealing). The purpose of performing dental root canal treatment is to remove infected dental pulp tissue inside the pulp chamber and root canals, and to fill/seal the vacant space with a biocompatible material. More specifically, the ultimate objective of root canal treatment is to eliminate the infection inside the dental root system and to tightly seal or obturate, in three dimensions (3-D), the tiny openings at the end of the root canal, (referred in the profession as an apex). Failure to completely seal the apex or the root canal in 3-D leads to micro-leakage, which will lead to future bacteria colonization inside the root canal system, and re-infection and possible loss of the tooth. Micro-leakage is the most common cause of tooth failure.

The last step of dental root canal treatment involving filling / obturating the cleaned and shaped root canal space is traditionally undertaken with a low thermo compound, commonly known as dental gutta percha (GP) material. Heretofore, root canal treatment processes involve placement of a root canal filling and/or sealing point or cone in a prepared root canal to plug the root canal, ideally in a manner to eliminate micro-leakage. More specifically, traditional root canal shaping and cleaning files are round shaped in cross section with single continuous taper across the entire file cutting section, from front tip end to rear end meeting the handle shaft. The existing filling points and the process of application thereof do not lend themselves well to providing a good seal of the root canal apex.

Another popular method to apply dental root canal filling material into root canal space today is called warm gutta percha technique. Part of this technique is to preheat and soften gutta percha material, then to squeeze/inject the softened gutta percha material into root canal space through a fine needle. Currently there are two types of applicator devices dominating the dental market for warm gutta percha technique. The first type of devices is a hot glue gun type. For example, the Obtura III Max system distributed by Obtura Spartan Endodontics company (http://www.obtura.com/products/obturation/obtura-max-system/823-800-obtura-iii-max.html). This device has a heating barrel/chamber that is part of the “gun” shaped applicator. A dentist operator puts a piece of cylindrical rod shaped gutta percha into the heating chamber and attaches a fine needle in front of the gun barrel/chamber. After activating the heat element in the gun barrel/chamber to soften the gutta percha material, the dentist pulls a trigger to push a piston rod into the heated gun barrel/chamber, so as to squeeze the softened gutta percha material through the fine needle into the prepared root canal in the patient. Since the gutta percha rod is directly inserted into heating chamber, after it is softened and dispensed, it leaves quite a sticky mess in the chamber (i.e., softened gutta percha is in direct contact with the chamber), which is required to be cleaned up with solvent chemicals to prepare the applicator device for the next use. The solvent vapor is harmful to, for example, expected mothers. Further, cross contamination among patients is a risk.

The second, newer type of applicator devices was designed to address some of the problems with the first type of devices. For example, the Calamus Dual 3D Obturation System distributed by Dentsply company (http://www.tulsadentalspecialties.com/default/endodontics_brands/Calamus.aspx). This device uses a gutta percha rod encased in a metal disposable cartridge having about 2.8 to 3.0 mm in diameter and 18 mm in length. One end of cartridge is connected to a fine needle, and the other end of the cartridge has a small nylon ball or pellet to seal off the cartridge end. Instead of a mechanical trigger configuration in the first type of applicator devices, the second type of applicator devices has a micro motor to move a piston forward to squeeze out gutta percha material through the needle. This second type is easier to clean, as the cartridge containing the gutta percha material is disposable.

The heating elements on both devices share a common design, with heating pads and/or heating coils located at the body of the heating chamber/barrel. This heating element design has shortcoming in in-vivo clinical applications. First problem is that given the placement of the heating coils on the body of the heating barrel, the barrel is very bulky. It is hard to use this device to reach to the back molar area in patient mouth. Second problem is that the heating mechanism is not efficient. There is an air space between gutta percha rod/cartridge and the heating element provided at the heating chamber of the device. Gutta percha material only needs about 90 to 125 degree Celsius to soften up. But dentists need to set the heating device to 155 degree Celsius minimum most of the time in order to have sufficient heat transferred from the heating element in the heating chamber on the device body across the air space to the separate cartridge containing the gutta percha rod. The higher operating temperature results in several clinical problems. One problem is that patients get their lip and cheek burned often. Dentists must use a thermo protective sleeve around the device body to protect patients, in turn making the device even bulkier. Given the heating element in the prior art applicator devices must be able to provide heat at higher temperature, the heating mechanism takes up more space, which further adds to the overall size of the device. Another problem is the heat transfer from the heating elements to the rod/cartridge is not consistent (given the air space between the rod/cartridge and the heating chamber is not always consistent). In the event of excessive heat transfer, it can overheat gutta percha rod and liquefy it to cause a run off, which would flow out of the needle before dentists are ready to use it.

It is desirable to develop a warm gutta percha applicator device that overcomes the drawbacks of the current devices noted above.

### SUMMARY OF THE INVENTION

The present invention provides an improved cartridge for storing root canal filling material and an applicator device for use with the cartridge, which overcomes the drawbacks of the prior art cartridges and applicator devices.

In accordance with the present invention, the inventive cartridge includes its own heating mechanism, built into the cartridge body. In one embodiment, the heating mechanism comprises an electrical heating element provided around the chamber of the cartridge body, which contains root canal filling material packed in the chamber. Electrodes are provided on the exterior of the cartridge body for the heating element. The cartridge is inserted into the barrel/chamber of an applicator device, with the cartridge electrodes coming into contact with electrodes provided on the applicator barrel/chamber walls, providing external power to the heating element on the cartridge.

With the root canal filling material packed into the chamber of the cartridge body having an integrated heating element, efficient heat transfer from the heating element to the material is achieved. Accordingly, heating to soften the filling material can be maintained at a minimum operating temperature without overheating. The barrel body of the applicator device does not require a thick heat insulating wall. Further, with built-in heating element in the cartridge which can efficiently and effectively heat the filling material therein at a relatively lower temperature, the size of the heating element can be kept small, so the overall size of the cartridge can be kept small, thus requiring a smaller chamber in the barrel of the applicator device. As a result, the overall size of the applicator device barrel can be kept to a minimum. More efficient heating results in a more efficient and compact applicator device that is easy to use to deliver the root canal filling material during a root canal procedure.

### BRIEF DESCRIPTION OF THE DRAWINGS

For a fuller understanding of the nature and advantages of the invention, as well as the preferred mode of use, reference should be made to the following detailed description read in conjunction with the accompanying drawings. In the following drawings, like reference numerals designate like or similar parts throughout the drawings.

FIG. 1A is a schematic sectional view of a heated cartridge containing dental filling material in accordance with one embodiment of the present invention; FIG. 1B is a sectional view taken along line 1B-1B in FIG. 1A.

FIG. 2A is a schematic sectional view of a heated cartridge containing dental filling material in accordance with one embodiment of the present invention; FIG. 2B is a sectional view taken along line 2B-2B in FIG. 2A.

FIG. 3A is a schematic view of a warm dental filling material applicator device in accordance with one embodiment of the present invention; FIG. 3B is a sectional view taken along line 3B-3B in FIG. 3A.

### DETAILED DESCRIPTION OF THE PREFERRED EMBODIMENTS

This invention is described below in reference to various embodiments with reference to the figures. While this invention is described in certain embodiments for achieving this invention's objectives, it will be appreciated by those skilled in the art that variations may be accomplished in view of these teachings without deviating from the scope and spirit of the invention.

The present invention focuses on applying heating source directly to the root canal filling material, inside a cartridge, by integrating heating element onto the cartridge into one compact unit. The advantages of this design include: 1) reducing the size of heating element and overall size of the cartridge, reducing the size of the applicator chamber/barrel and overall size of the applicator for easy use; 2) making heating temperature more consistent across the filling material in the cartridge; and 3) reducing heat loss by eliminating air gaps between the filling material and the heating element in the cartridge, resulting in lower working temperature for better patient safety and better consistency in delivering gutta percha material in use, and a more efficient and compact applicator device.

The present invention will be described herein-below in reference to root canal filling material generally known as gutta percha, for example. However it is understood that the present invention could be applied to root canal filling materials based on other types of endodontic filler materials, currently known or future discovered, without departing from the scope and spirit of the present invention.

In accordance with the present invention, the inventive cartridge has a smaller overall size and/or shape. It can accommodate a smaller diameter root canal filling material (e.g., gutta percha) rod. Accordingly to the invention, a heat source is integrated in the cartridge containing the root canal filling material. This reduces the size of the applicator that receives the cartridge by a large measure. The size of the device is much smaller for better reachability in the patients' mouths. Heating of the root canal filling material is more direct and hence more effective heat transfer. This will ensure the entire root canal filling material (e.g., gutta percha) gets heated and softened in a more evenly fashion and at lower temperature. The device temperature setting will be significantly lower to soften the root canal filling material. This will reduce the trauma to patients from heat burns.

In accordance with the present invention, the heat source may be a heating element that is directly integrated (e.g., embedded, wrapped, printed, coated, painted) into the cartridge. This may be accomplished in various ways, as elaborated below.

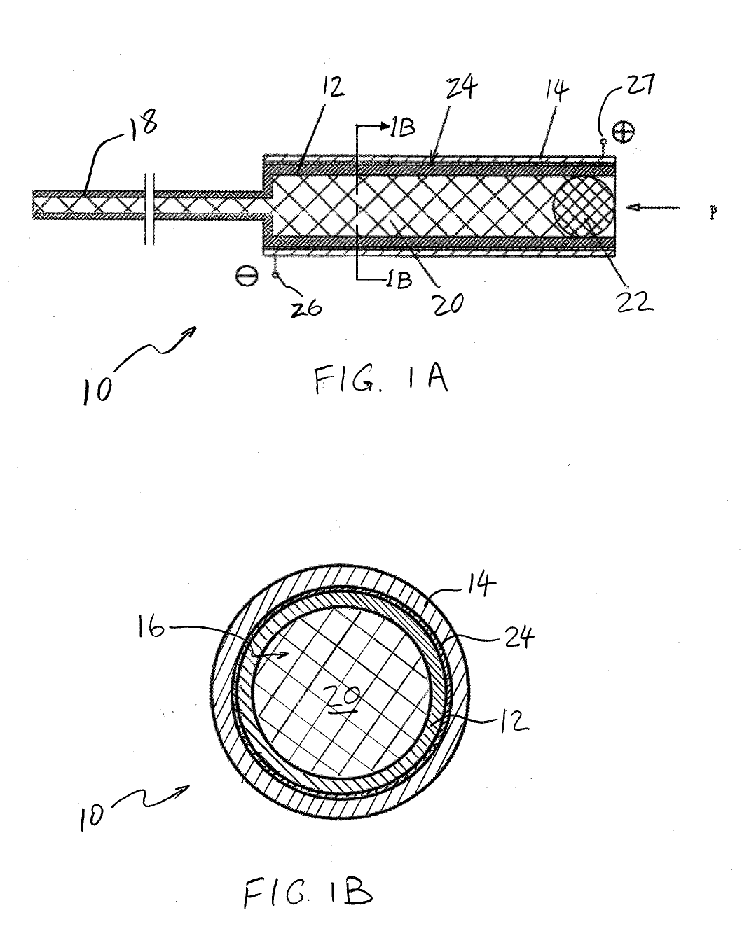

FIGS. 1A and 1B illustrates the sectional view of one embodiment of a cartridge in accordance with the present invention. The cartridge 10 includes a cylindrical body 12, having a heating element 14 provided on the body 12. The body 12 has walls defining an interior cylindrical chamber 16. A thin needle 18 having a through-bore extends from one end of the cylindrical body 12. The needle may be attached to the end of the cartridge body 12 by a threaded joint, welding, gluing, or other suitable attachment means. The chamber 16 retains root canal filling material 20 that can be softened by heat (e.g., gutta percha material). To eliminate air gap between the cartridge body 12 and the material 20 which would otherwise result in heat transfer losses, the gutta percha material is tightly packed in the chamber. For example, a precision made gutta percha rod having an external diameter matching the internal diameter of the cartridge cylindrical body 12 is tightly pressed into the cartridge chamber 16. Another method is to inject heated and softened gutta percha material into the cartridge chamber 16, then packing the gutta percha material tightly in the chamber to avoid air entrapment for better heat conductivity (vacuum may be applied to remove residual air in the cartridge chamber prior to packing) In other words, the gutta percha material 20 is substantially in contact relationship with at least the cylindrical walls of the cartridge chamber 16 to provide a good contact heat transfer interface. A seal 22 (schematically shown as a ball seal), is provided to plug the opened end of the cartridge body 22 after packing This seal 22 acts as a piston, which can be used to push softened root canal filling material out of the needle 18 by a force P.

The cartridge body 12 and the needle 18 may be made of a good heat conducting material, such as a metal. As shown in the embodiment of FIGS. 1A and 1B, the heating element 14 is provided on the outside of the metal body 12. The heating element 14 may be a Joule heating element (or resistive or ohmic heating elements), such as in the form of a resistive coil wrapped around the outside of the metal body 12. The metal body 12 distributes heat in a desired manner to facilitate softening of the material 20. For example, heat may be evenly and/or uniformly distributed along the cartridge chamber 16 (with the resistive element extending along substantially the length of the cartridge chamber), or in a specific heat distribution pattern along the axial length of the cartridge chamber 16, such as higher heat at the section nearer to the needle end of the cartridge chamber and lower heat at the section at the other end of the plugged end of the cartridge chamber 16 (e.g., with heating element provided along part of the cartridge body 12, in the section closer to the needle end only). In the latter situation, higher heated zone softens the section of the material 20 nearer the needle 18 sufficiently to be pushed out of the small bore needle 18, and lower heated zone pre-heats the material 20 at the section further from the needle, which can still be pushed down the chamber 16 towards the needle 18. As the preheated section of material 20 reaches the higher heat zone nearer the needle 18, it receives more heat to be soften sufficiently to be pushed out of the significantly smaller bore of the needle 18.

The heating element 14 may comprise conventional material that heats up with the passage of an electrical current. For example, the heating element 14 may include a resistive heating element. The resistive heating element 14 may be in the form of a layer of resistive coating, or in the form of a coil or wire. Known method of forming printed circuits may be applied to form the resistive element on the cartridge body 12. In the illustrated embodiment, an insulator layer 24 is disposed (e.g., printed, painted, deposited, coated, etc.) between the outer surface of the metal cartridge body 12 and the heating element 14. Then a pre-specified resistive film material is disposed over the insulation layer. The selection of the resistive value, the specification/threshold of the heating element is based in large part on the amount of heat need to be generated to soften the gutta percha material 20 retained in the cartridge chamber 16.

Two electrodes 26 and 27 (positive and negative) are attached to the opposite ends (or other appropriate locations) of the resistive heating element 14. The two electrodes 26 and 27 are connected to an external DC power source (not shown). For example, the power supply parameters may be: 8-10 Watts and 9-12 Volts DC, and the resistive heating element may have resistance at 10 Ohm, to produce temperature range between 85 and 125 degree Celsius. The power source may be configured to regulate the voltage applied to the heating element. When a selected temperature is reached at the cartridge chamber 16, a voltage regulator in the power source will regulate the voltage to ensure consistent heating at the desired temperature. The heating element 14 may include a protective coating (not specifically shown) commonly found on heating elements.

The needle 18 attached to the cartridge can be of most commonly used gauges, 21G, 23G, and 25G, with 25 to 32 mm in length. While the needle 18 is illustrated as a straight needle, it may be configured with one or more bents to facilitate ease of use to deliver gutta percha material to deliver hard to reach root canals. In one embodiment, the cartridge chamber 16 has an internal diameter of about 2.0 mm and an external diameter of about 3.0-4.0 mm. The heating element 14 (e.g., resistive element) may be less than about 2.5 mm thick.

In an alternate embodiment (not shown), the heating element (e.g., resistive heating element) may be encased or integral in the metal body 12 (e.g., sandwiched within the walls of the metal body 12). Alternatively, not shown, the heating element may be provided on the inside wall of the body 12. In which case, a suitable coating material is provided over the heating element, so that the heating element does not burn the root canal filling material, and to facilitate pushing of the piston 2 down the barrel.

The cartridge 10 in accordance is adapted to be received in the chamber or barrel of an applicator device (e.g., in a manner similar to the applicator devices in the prior art, including a push rod or pin to push the ball seal 22), with the exception that electrical contacts should be provided in the applicator to connect external power supply to the electrodes 26 and 27 found on the cartridge body 12. The inventive cartridge 10 is a one-time-use disposable item, and designed to be manufactured at a low cost. A fresh cartridge is inserted in the barrel of the applicator, and the spent cartridge is removed after use, without having to clean root canal filling material from the chamber barrel of the applicator, other than sanitizing and/or sterilization of the applicator, if required for dental tools of this nature. The cross-section of the cylindrical cartridge body may be generally circular or other geometry. The applicator chamber barrel is configured to receive the external size and shape of the cartridge body 12.

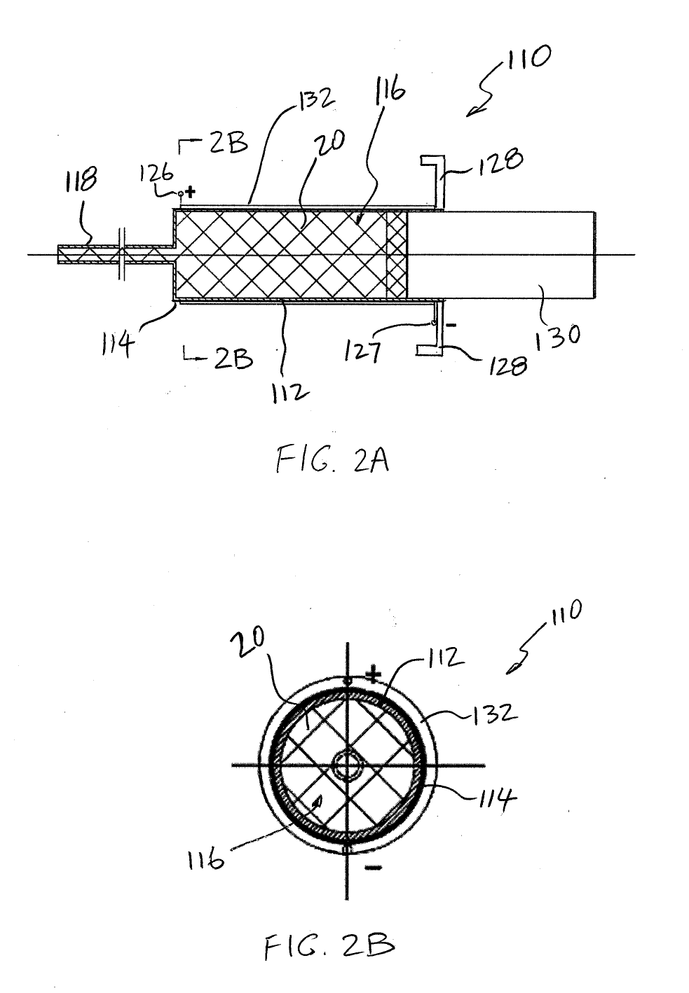

Referring to FIGS. 2A and 2B, the cartridge 110 includes a cylindrical body 112, having a heating element 114 provided on the body 112. The body 112 has walls defining an interior cylindrical chamber 116. A thin needle 118 having a through-bore extends from one end of the cylindrical body 112. The chamber 116 retains root canal filling material 20 that can be softened by heat (e.g., gutta percha material). To eliminate air gap between the cartridge body 112 and the material 20 which would otherwise result in heat transfer losses, the gutta percha material is tightly packed in the chamber. For example, a precision made gutta percha rod having an external diameter matching the internal diameter of the cartridge cylindrical body 112 is tightly pressed into the cartridge chamber 116. A seal 122 is provided at the opened end of the cartridge chamber. In this embodiment, a protective outer layer 132 is provided around the heating element 114. Compared to the embodiment of FIGS. 1A and 1B, the inventive cartridge 210 may be configured for use standing alone, by providing an appropriate user handle 128 attachment to the piston end of the cartridge 110, including a pushing rod/pin 130 to push the seal 122, and contact sockets to connect the external power supply to the electrodes 126 and 127.

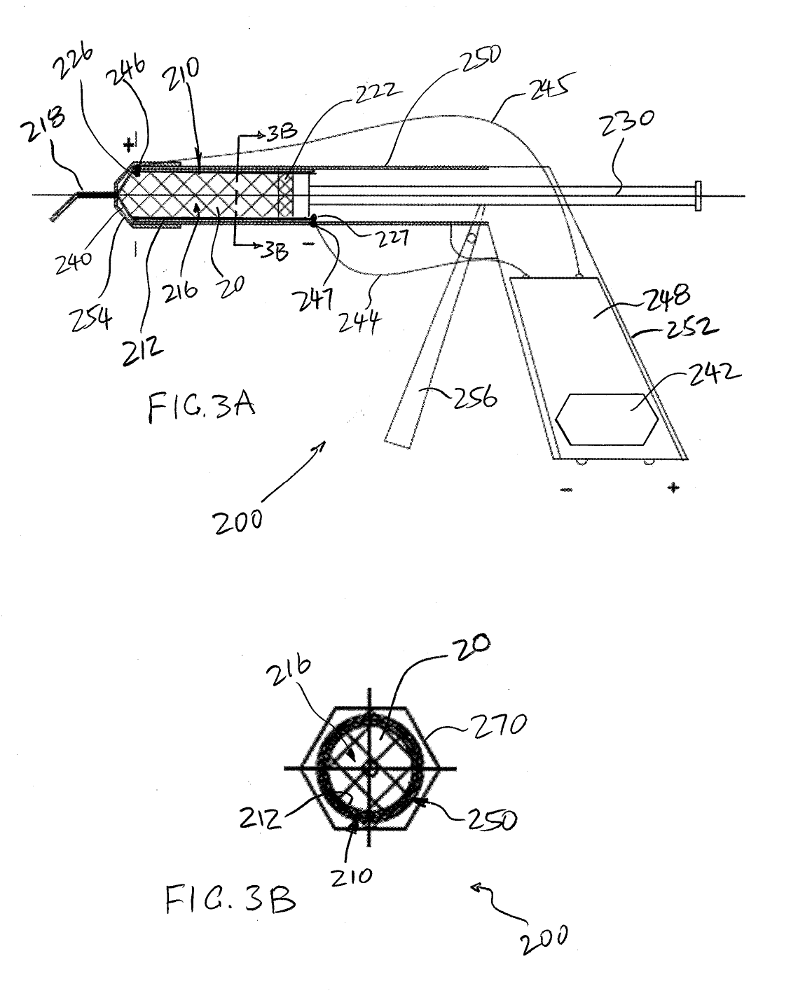

FIGS. 3A and 3B schematically illustrates an embodiment of an applicator device 200, which is configured to use a self-heated cartridge 210 that includes a heating mechanism similar to the cartridges disclosed above. In this embodiment, to simplify the drawing view so as not to obscure discussion, the various layers (including heating element and other layers) on the cartridge body 212 are not shown. However, these layers (including the heating element) are found on the cartridge body 212, in a similar manner as in the earlier disclosed embodiments.

In this embodiment, the cartridge 210 include a conical end wall 240 from which the needle 318 extends. The needle 218 is provided with a bent.

The applicator device 200 include a hollow barrel portion 250 attached to a handle portion 252, generally conforming to the configuration of a hand-gun. The barrel 250 has a hollow cylindrical internal chamber that is sized to receive the cartridge 210. A cap 254 securely attaches to cover the end of the barrel 250 after inserting the cartridge 210 into the barrel 250. The cap 254 may be securely attached to the end of the barrel 250 with a screw coupling (like a screw-on bottle cap) or by a twist coupling (like a twist on medicine bottle cap). A piston rod 230 extending from the handle end of the barrel 250 presses against the seal 222 to deliver gutta percha material 20 contained in the cartridge chamber 216 through the needle 218. A finger grip 256 is pivotally attached at the handle 250, and is configured to bias the piston rod 230 against the seal 222 in the cartridge. Alternatively (not shown), the piston rod 230 may be configured to be actuated by an electric motor to press against the seal 222. The finger grip 256 may be configured to activate the electric motor.

As schematically illustrated in FIG. 3A, appropriate switches and/or control electronics (schematically collectively shown by box 248 in FIG. 3A) may be provided to control electrical operation of the heating process, including temperature feedback control, etc. The control electronics may be provided external of the applicator device 200, controlling the heating element and other operations of the applicator device 200 via a cable (not shown). Such electronic control is by itself well known in the art. One skill in the art would be able to implement appropriate controls to achieve the operation objectives using the inventive cartridge and applicator device.

A power supply in the form of a battery 242 is provided in the handle 252 (which may be part of the control 248) to provide power source to the heating element 214 and control 248. Alternatively (not shown), the power supply may be external of the applicator device 200, supplying power via a cable (not shown).

Wires 244 and 245 provide electrical leads from the control 248 and battery 242 to electrodes 246 and 247 provided at the inside surface of the barrel 250, to provide electrical interface to the heating element 214. (While the wires 244 and 245 are schematically shown as unsupported, it is understood that the wires 244 and 245 can be run along a support, e.g., along the barrel.) The electrodes 246 and 247 are provided at locations matching up with the electrodes 126 and 127 provided on the cartridge body 212 (similar to the electrodes 26 and 27 provided on the cartridge body 12 in FIG. 1A, and the electrodes 126 and 127 provided on the cartridge body 112 in FIG. 2A) after the cartridge 210 is securely inserted into the barrel 250 in preparation for operation for heating and delivery of the gutta percha material 20 through the needle 218.

The applicator barrel 250 may be made of a light weight material, such as a metal or plastic. It is noted that the barrel 250 of the applicator device 200 need not be a sealed tube. The barrel 250 may have an open structure, which expose part of the piston rod 230 and/or the cartridge 210, as long as the barrel 250 securely supports and align the cartridge 210 with respect to the piston rod 230, which is actuated to push root canal filler material contained in the cartridge chamber 216. An optional housing may 270 be provided around the barrel 250 (as shown in FIG. 3B).

While the embodiments disclosed above include an integrated needle attached to the cartridges, it is contemplated that alternatively (not shown), the cartridge may omit a needle, and a needle may be a component attached to the tip end of an applicator device. For example, the needle may be configured with an attached conical funnel structure, which can be fitted over and/or to the end of an applicator or the end of a cartridge, to allow softened root canal filling material to be delivered from the cartridge chamber 216 through the needle 218. Further, while the above-described embodiments include a heating element that is provided at the periphery of the cartridge, it is contemplated that a heating element may be alternatively or additionally provided within the chamber of the cartridge, to be built-in the cartridge to provide heating to the root canal filler material contained therein.

With the root canal filling material packed into the chamber of the cartridge body having an integrated heating element, efficient heat transfer from the heating element to the material is achieved. Accordingly, heating to soften the filling material can be maintained at a minimum operating temperature without overheating. The barrel body of the applicator device does not require a thick heat insulating wall. Further, with built-in heating element in the cartridge which can efficiently and effectively heat the filling material therein at a relatively lower temperature, the size of the heating element can be kept small, so the overall size of the cartridge can be kept small, thus requiring a smaller chamber in the barrel of the applicator device. As a result, the overall size of the applicator device barrel can be kept to a minimum. More efficient heating results in a more efficient and compact applicator device that is easy to use to deliver the root canal filling material during a root canal procedure.

A further design consideration would be to conform to published guidelines concerning electromagnetic interference with bio-medical devices (e.g., pacemakers) found on patients. With more people in general population have implantable heart defibrillation devices, it is believed that the inventive cartridge device having internal electro-heating mechanism would have less interference with patients' delicate electronic medical devices, such as implantable heart defibrillator.

While the present invention has been described above in connection with the illustrated embodiments, the scope of patent invention covers all possible present and future variations and improvements that is apparent from the disclosure above. While the invention has been particularly shown and described with reference to the preferred embodiments, it will be understood by those skilled in the art that various changes in form and detail may be made without departing from the spirit, scope, and teaching of the invention. Accordingly, the disclosed invention is to be considered merely as illustrative and limited in scope only as specified in the appended claims.

We claim:

1. A cartridge for storing a root canal filling material, comprising:
a body having a chamber storing the root canal filling material; and
an electrical heating element that can be activated to apply heat to soften the root canal filling material.

2. The cartridge as in claim 1, wherein the heating element further comprises electrodes conductively exposed outside the cartridge body.

3. The cartridge as in claim 2, wherein the heating element is built-in the body.

4. The cartridge as in claim 2, wherein the heating element is provide on the exterior of the body.

5. The cartridge as in claim 2, wherein the heating element comprises a resistive heating element.

6. The cartridge as in claim 1, wherein root canal filling material is tightly packed in the chamber of the cartridge so that the root canal filling material substantially contacts the walls of the chamber to provide contact heat transfer from the walls to the root canal filling material.

7. The cartridge as in claim 1, further comprising a needle extending from one end of the cartridge and in flow communication to the chamber.

8. The cartridge as in claim 7, further comprising a seal at another end of the chamber.

9. The cartridge as in claim 8, wherein when the heating element applies heat to soften the root canal filling material so that it can be pushed through the needle by applying pressure on the seal.

10. The cartridge as in claim 8, wherein the seal is a ball plugged into said another end of the chamber.

11. The cartridge as in claim 1, wherein the body is sized to be received in an applicator device.

12. An applicator device for delivering root canal filling material to a patient, comprising:
a hollow barrel receiving the cartridge as in claim 2;
electrodes provided on inside walls of the barrel, located to match up with the electrodes conductively exposed outside the cartridge body; and
a piston that is actuated to push heated root canal filling material out of the chamber.

13. The applicator device as in claim 12, further comprising a power supply providing power to the heating element in the cartridge.

14. The applicator device as in claim 12, wherein the cartridge comprises a needle extending from one end of the cartridge and in flow communication to the chamber, and a seal at another end of the chamber, and wherein the piston applies pressure on the seal to push heated gutta percha material through the needle in the cartridge.

15. The applicator device as in claim 12, further comprising a handle attached to the barrel.

16. The applicator device as in claim 15, further comprising a finger grip coupled to the piston to actuate the piston.
